(19) United States
(12) Patent Application Publication
(10) Pub. No.: US 2023/0280494 A1
(43) Pub. Date: Sep. 7, 2023

(54) PROPER LAYOUT OF DATA IN GPUS FOR ACCELERATING LINE SOLVE PRE-CONDITIONER USED IN ITERATIVE LINEAR SOLVERS IN RESERVOIR SIMULATION

(71) Applicant: SAUDI ARABIAN OIL COMPANY, Dhahran (SA)

(72) Inventors: Maitham M. Alhubail, Qatif (SA); Usuf Middya, Dhahran (SA); Ali H. Dogru, Dhahran (SA)

(73) Assignee: SAUDI ARABIAN OIL COMPANY, Dhahran (SA)

(21) Appl. No.: 18/176,768

(22) Filed: Mar. 1, 2023

Related U.S. Application Data
(60) Provisional application No. 63/315,383, filed on Mar. 1, 2022.

(51) Int. Cl. G01V 99/00

(52) U.S. Cl. CPC G01V 99/005

(57) ABSTRACT

A computer implemented method and system for simulating a hydrocarbon reservoir. The method includes determining a computational reservoir model, comprising formation data and fluid pressure data for each of a plurality of reservoir cells, and forming a tridiagonal matrix system for each of M strongly connected lines and arranging arrays of the M tridiagonal matrix systems in a level-based data layout to be stored in a memory of a graphical processing unit (GPU). The method further includes to determining, with the GPU, an unknown potential array for each of the tridiagonal matrix systems by solving the tridiagonal matrix systems simultaneously using a Thomas method configured to operate with the level-based data layout.

### BACKGROUND

In the oil and gas industry many systems (such as drilling systems, well systems, reservoir simulations systems, data acquisition systems, data processing systems, etc.) and techniques (such as Artificial Intelligence, Machine Learning, Deep Learning, modeling, inversion, imaging, etc.) rely, at least in part, on processes that may be conducted on a graphical processing unit (GPU). In order to make computations using data sets and models that may be extremely large, but can vary widely in size and complexity it may be desirable to ensure that GPU architecture, data layout, pre-conditioning, and memory access are optimally managed.

It is known that linear systems that arise from reservoir simulations may be solved with stiff and iterative linear solvers, such as generalized minimal residual (GMRES) method, which benefit greatly when combined with pre-conditioners. One very strong pre-conditioner is a linear solver where the lines with the strongest connectivity in the reservoir may be solved using direct methods. The data of each strongly connected line may be represented as a tridiagonal matrix linear system which may be solved using the Thomas algorithm. Solving the tridiagonal linear system using the Thomas algorithm involves two primary passes often called “forward” and “backward” passes. This process may be computationally expensive and inefficient. Accordingly, there exists a need to implement methods for making these computations more efficient.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a computer implemented method and system for simulating a hydrocarbon reservoir. The method includes determining a computational reservoir model, comprising formation data and fluid pressure data for each of a plurality of reservoir cells, and forming a tridiagonal matrix system for each of M strongly connected lines and arranging arrays of the M tridiagonal matrix systems in a level-based data layout to be stored in a memory of a graphical processing unit (GPU). The method further includes to determining, with the GPU, an unknown potential array for each of the tridiagonal matrix systems by solving the tridiagonal matrix systems simultaneously using a Thomas method configured to operate with the level-based data layout.

Embodiments disclosed herein generally relate to a system that includes a computational reservoir simulator configured to simulate a hydrocarbon reservoir and a computer processor. The computer processor is configured to receive a tridiagonal matrix system for each of M strongly connected lines in the hydrocarbon reservoir, where M is an integer greater than or equal to 1, and where each tridiagonal matrix system includes an unknown potential array containing a number of levels. The computer processor is further configured to store, according to a level-based data layout, the M tridiagonal matrix systems in a memory of a graphical processing unit (GPU), determine, using the GPU, the unknown potential array for each of the tridiagonal matrix systems simultaneously by using a Thomas method configured to operate with the level-based data layout, and determine the flow profile and production rate of each of one or more wells that traverse the hydrocarbon reservoir with a reservoir simulation based on the determined potential arrays of each of the tridiagonal matrix systems using the computational reservoir simulator.

Embodiments disclosed herein generally relate to a non-transitory computer readable medium storing instructions executable by a computer processor, the instructions including functionality for receiving a tridiagonal matrix system for each of M strongly connected lines in a hydrocarbon reservoir, where M is an integer greater than or equal to 1, and where each tridiagonal matrix system includes an unknown potential array containing a number of levels. The non-transitory computer readable medium further includes instructions for storing, according to a level-based data layout, the M tridiagonal matrix systems in a memory of a graphical processing unit (GPU) and determining, using the GPU, the unknown potential array for each of the tridiagonal matrix systems simultaneously by using a Thomas method configured to operate with the level-based data layout.

Other aspects and advantages of the claimed subject matter will be apparent from the following description and the appended claims.

### BRIEF DESCRIPTION OF DRAWINGS

FIG. 1 illustrates a well environment in accordance with one or more embodiments.

FIG. 2A depicts a drilling system in accordance with one or more embodiments.

FIG. 2B depicts a drilling system in accordance with one or more embodiments.

FIG. 3 illustrates a well system in accordance with one or more embodiments.

FIG. 4A depicts a geological region in accordance with one or more embodiments.

FIB. 4B depicts a reservoir simulator in accordance with one or more embodiments.

FIG. 5 shows a schematic diagram of a well model for simulation based on an explicit model methodology illustrated in radial geometry.

FIG. 6 shows a schematic diagram of a well model for simulation based on a fully implicit, fully coupled model methodology.

FIG. 7 shows a schematic diagram of a finite difference grid system in accordance with one or more embodiments.

FIG. 8 shows a schematic diagram of a linear system of equations with a tridiagonal coefficient matrix for a constant bottom hole pressure well model for a one-dimensional reservoir simulator with a vertical well for processing in accordance with one or more embodiments.

FIG. 9 shows a schematic diagram of a linear system of equations with a tridiagonal coefficient matrix for an explicit well model for a one-dimensional reservoir simulator with a vertical well in accordance with one or more embodiments.

FIG. 10 shows a schematic diagram of a tridiagonal coefficient matrix in accordance with one or more embodiments.

FIG. 11 shows a schematic diagram of a linear system of equations with a tridiagonal coefficient matrix in accordance with one or more embodiments.

FIG. 12 shows a schematic of a graphical processing unit (GPU) in accordance with one or more embodiments.

FIG. 13 illustrates line data as a tridiagonal matrix system in accordance with one or more embodiments.

FIG. 14 illustrates a line-based data layout in memory for a tridiagonal system's arrays in accordance with one or more embodiments.

FIG. 15 illustrates a level-based data layout in accordance with one or more embodiments.

FIG. 16 shows a line-based kernel code in accordance with one or more embodiments.

FIG. 17 shows a level-based kernel code in accordance with one or more embodiments.

FIG. 18 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

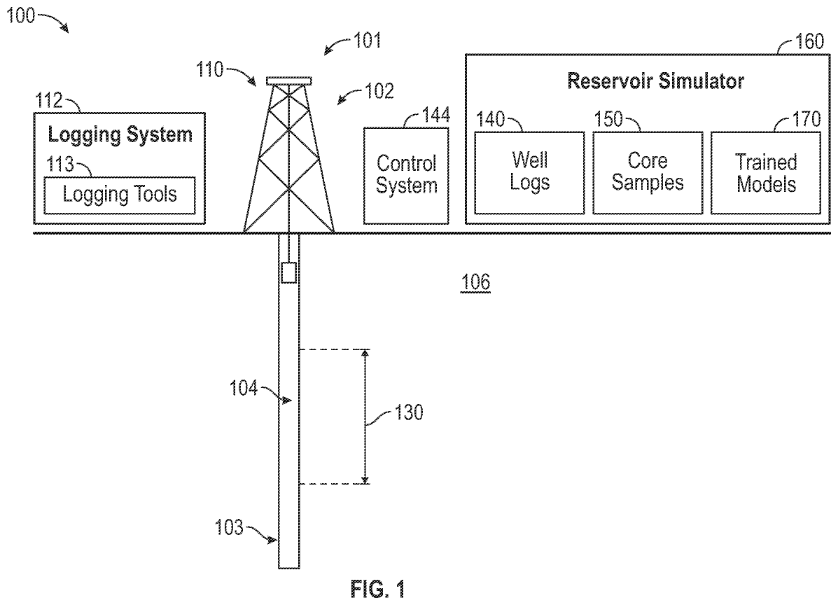

In the description of FIGS. 1-18, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In order for the present disclosure to be more readily understood, certain terms are first defined below. Additional definitions for the following terms and other terms are set forth throughout the specification.

An apparatus, composition, or method described herein as “comprising” one or more named elements or steps is open-ended, meaning that the named elements or steps are essential, but other elements or steps may be added within the scope of the composition or method. To avoid prolixity, it is also understood that any apparatus, composition, or method described as “comprising” (or which “comprises”) one or more named elements or steps also describes the corresponding, more limited composition or method “consisting essentially of” (or which “consists essentially of”) the same named elements or steps, meaning that the composition or method includes the named essential elements or steps and may also include additional elements or steps that do not materially affect the basic and novel characteristic(s) of the composition or method. It is also understood that any apparatus, composition, or method described herein as “comprising” or “consisting essentially of” one or more named elements or steps also describes the corresponding, more limited, and closed-ended composition or method “consisting of” (or “consists of”) the named elements or steps to the exclusion of any other unnamed element or step. In any composition or method disclosed herein, known or disclosed equivalents of any named essential element or step may be substituted for that element or step.

As used herein, the terms “neural network” and “correlation matrix” may be used interchangeably and may refer to systems and methods that relate at least one input parameter to at least one output parameter of a system, and quantify such relationships between input and output parameters. Neural networks and correlation matrices may be built autonomously via one or more computer-implemented systems, and may also be built in connection with one or more human inputs.

As used herein, the term “inversion” may be used synonymously with the term “optimization.”

As used herein, the terms “machine-learning”, “artificial intelligence,” “cognitive reasoning,” “autonomous systems,” “adaptive algorithms,” “deep learning,” and “heuristics” may all describe systems, methods, protocols, and apparatuses that search for and establish correlations that are at least partially predictive of at least one output or result, at least some percent of the time, without requiring previous programming or instruction for every executable step, and without needing to be 100% predictive in every situation.

It is to be understood that the singular forms “a,” “an,” and “the” include plural referents unless the context clearly dictates otherwise. Thus, for example, reference to “a graphical processing unit (GPU)” includes reference to one or more of such GPUs.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Embodiments disclosed herein relate to arranging line solver data in GPU memory in a way that maximizes cache use and minimizes access to GPU global memory. The arrangement of data as disclosed herein has the possibility of gaining about 4× speed-up compared to standard layoust used in most existing GPU implementations for achieving the same objective. Embodiments disclosed herein propose and implement a data layout idea that combines both the data dependency and the GPU threads memory access patterns. More specifically, embodiments disclosed herein implement an idea that greatly improves the runtime of the two passes of the Thomas algorithm when the implementation is executed on the GPU platform.

FIG. 1 shows a schematic diagram in accordance with one or more embodiments. FIG. 1 illustrates a well environment (100) that may include a well system (101), a well (102) with a wall (103) having a wellbore (104) extending into a formation (106). The wellbore (104) may include a bored hole that extends from the surface into a target zone of the formation (106), such as a reservoir (not shown). The formation (106) may include various formation characteristics of interest, such as formation porosity, formation permeability, resistivity, water saturation, and free water level (FWL). Porosity may indicate how much void space exists in a particular rock within an area of interest in the formation (106), where oil, gas or water may be trapped. Permeability may indicate the ability of liquids and gases to flow through the rock within the area of interest. Resistivity may indicate how strongly rock or fluid within the formation (106) opposes the flow of electrical current. For example, resistivity may be indicative of the porosity of the formation (106) and the presence of hydrocarbons. More specifically, resistivity may be relatively low for a formation that has high porosity and a large amount of water, and resistivity may be relatively high for a formation that has low porosity or includes a large quantity of hydrocarbons. Water saturation may indicate the fraction of water in a given pore space.

Keeping with FIG. 1, the well environment (100) may include a drilling system (110), a logging system (112), a control system (144), and a reservoir simulator (160). The drilling system (110) may include a drill string, drill bit or a mud circulation system for use in boring the wellbore (104) into the formation (106). The control system (144) may include hardware or software for managing drilling operations or maintenance operations. For example, the control system (144) may include one or more programmable logic controllers (PLCs) that include hardware or software with functionality to control one or more processes performed by the drilling system (110). Specifically, a programmable logic controller may control valve states, fluid levels, pipe pressures, warning alarms, or pressure releases throughout a drilling rig. In particular, a programmable logic controller may be a ruggedized computer system with functionality to withstand vibrations, extreme temperatures (for example, ˜575° C.), wet conditions, or dusty conditions, for example, around a drilling rig. Without loss of generality, the term “control system” may refer to a drilling operation control system that is used to operate and control the equipment, a drilling data acquisition and monitoring system that is used to acquire drilling process and equipment data and to monitor the operation of the drilling process, or a drilling interpretation software system that is used to analyze and understand drilling events and progress.

The logging system (112) may include one or more logging tools (113), such as a nuclear magnetic resonance (NMR) logging tool or a resistivity logging tool, for use in generating well logs (140) of the formation (106). For example, a logging tool may be lowered into the wellbore (104) to acquire measurements as the tool traverses a depth interval (130) (for example, targeted reservoir section) of the wellbore (104). The plot of the logging measurements versus depth may be referred to as a “log” or “well log”. Well logs (104) may provide depth measurements of the well (102) that describe such reservoir characteristics as formation porosity, formation permeability, resistivity, water saturation, and the like. The resulting logging measurements may be stored or processed or both, for example, by the control system (144), to generate corresponding well logs (140) for the well (102). A well log may include, for example, a plot of a logging response time versus true vertical depth (TVD) across the depth interval (130) of the wellbore (104).

Reservoir characteristics may be determined using a variety of different techniques. For example, certain reservoir characteristics can be determined via coring (for example, physical extraction of rock samples) to produce core samples (150) or logging operations (for example, wireline logging, logging-while-drilling (LWD) and measurement-while-drilling (MWD)). Coring operations may include physically extracting a rock sample from a region of interest within the wellbore (104) for detailed laboratory analysis. For example, when drilling an oil or gas well, a coring bit may cut plugs (or “cores”) from the formation (106) and bring the plugs to the surface, and these core samples may be analyzed at the surface (for example, in a lab) to determine various characteristics of the formation (106) at the location where the sample was obtained. One example of a reservoir characteristic is the amount of oil present in the reservoir, and monitoring or observing the depletion of oil from the reservoir. Reservoir monitoring is an operation involving the mapping of fluid movements within the reservoir as a consequence of oil production.

Multiple types of logging techniques are available for determining various reservoir characteristics, and a particular form of logging may be selected and used based on the logging conditions and the type of desired measurements. For example, NMR logging measures the induced magnetic moment of hydrogen nuclei (that is, protons) contained within the fluid-filled pore space of porous media (for example, reservoir rocks). Thus, NMR logs may measure the magnetic response of fluids present in the pore spaces of the reservoir rocks. In so doing, NMR logs may measure both porosity and permeability as well as the types of fluids present in the pore spaces. For determining permeability, another type of logging may be used that is called spontaneous potential (SP) logging. SP logging may determine the permeabilities of rocks in the formation (106) by measuring the amount of electrical current generated between a drilling fluid produced by the drilling system (110) and formation water that is present in pore spaces of the reservoir rock. Porous sandstones with high permeabilities may generate more electricity than impermeable shales. Thus, SP logs may be used to identify sandstones from shales.

To determine porosity in the formation (106), various types of logging techniques may be used. For example, the logging system (112) may measure the speed that acoustic waves travel through rocks in the formation (106). This type of logging may generate borehole compensated (BHC) logs, which are also called sonic logs and acoustic logs. In general, sound waves may travel faster through shales than through sandstones because shales generally have greater density than sandstones. Likewise, density logging may also determine porosity measurements by directly measuring the density of the rocks in the formation (106). In addition, neutron logging may determine porosity measurements by assuming that the reservoir pore spaces within the formation (106) are filled with either water or oil and then measuring the amount of hydrogen atoms (that is, neutrons) in the pores. Furthermore, the logging system (112) may determine geological data for the well (102) by measuring corresponding well logs (140) and data regarding core samples (150) for the well (102).

Keeping with the various types of logging techniques, resistivity logging may measure the electrical resistivity of rock or sediment in and around the wellbore (104). In particular, resistivity measurements may determine what types of fluids are present in the formation (106) by measuring how effective these rocks are at conducting electricity. Because fresh water and oil are poor conductors of electricity, they have high relative resistivities. For example, an electrical resistivity of oil ranges from 4.5×10⁶ to 1.5×10⁸ Ohm-meter and the electrical resistivity of freshwater aquifers is in the range of 10-100 Ohm-meter. As such, resistivity measurements obtained via such logging can be used to determine corresponding reservoir water saturation (S_{w}).

Turning to the reservoir simulator (160), the reservoir simulator (160) may include hardware or software with functionality for generating one or more trained models (170) regarding the formation (106). For example, the reservoir simulator (160) may store well logs (140) and data regarding core samples (150), and further analyze the well log data, the core sample data, seismic data, or other types of data to generate or update the one or more trained models (170) having a complex geological environment. For example, different types of models may be trained, such as artificial intelligence, convolutional neural networks, deep neural networks, support vector machines, decision trees, inductive learning models, deductive learning models, and supervised learning models, and are capable of approximating solutions of complex non-linear problems. The reservoir simulator (160) may couple to the logging system (112) and the drilling system (110). The reservoir simulator hardware and software may be located away from the well environment. The reservoir simulator will be described in more detail in later figures and descriptions.

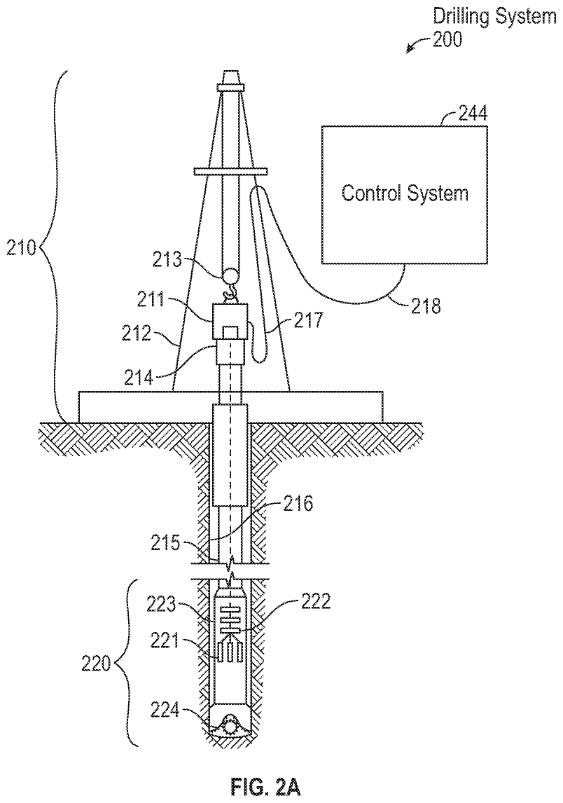

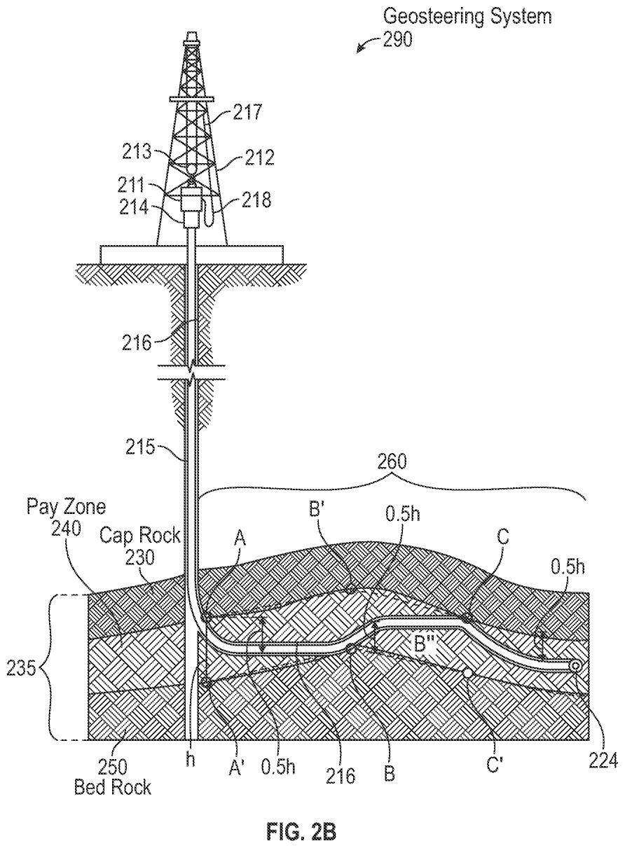

FIGS. 2A and 2B illustrate drilling systems in accordance with one or more embodiments. As shown in FIG. 2A, a drilling system (200) may include a top drive drill rig (210) arranged around the setup of a drill bit logging tool (220). A top drive drill rig (210) may include a top drive (211) that may be suspended in a derrick (212) by a travelling block (213). In the center of the top drive (211), a drive shaft (214) may be coupled to a top pipe of a drill string (215), for example, by threads. The top drive (211) may rotate the drive shaft (214), so that the drill string (215) and a drill bit logging tool (220) cut the rock at the bottom of a wellbore (216). A power cable (217) supplying electric power to the top drive (211) may be protected inside one or more service loops (218) coupled to a control system (244). As such, drilling mud may be pumped into the wellbore (216) through a mud line, the drive shaft (214), and/or the drill string (215).

Moreover, when completing a well, casing may be inserted into the wellbore (216). The sides of the wellbore (216) may require support, and thus the casing may be used for supporting the sides of the wellbore (216). As such, a space between the casing and the untreated sides of the wellbore (216) may be cemented to hold the casing in place. The cement may be forced through a lower end of the casing and into an annulus between the casing and a wall of the wellbore (216). More specifically, a cementing plug may be used for pushing the cement from the casing. For example, the cementing plug may be a rubber plug used to separate cement slurry from other fluids, reducing contamination and maintaining predictable slurry performance. A displacement fluid, such as water, or an appropriately weighted drilling mud, may be pumped into the casing above the cementing plug. This displacement fluid may be pressurized fluid that serves to urge the cementing plug downward through the casing to extrude the cement from the casing outlet and back up into the annulus.

As further shown in FIG. 2A, sensors (221) may be included in a sensor assembly (223), which is positioned adjacent to a drill bit (224) and coupled to the drill string (215). Sensors (221) may also be coupled to a processor assembly (223) that includes a processor, memory, and an analog-to-digital converter (222) for processing sensor measurements. For example, the sensors (221) may include acoustic sensors, such as accelerometers, measurement microphones, contact microphones, and hydrophones. Likewise, the sensors (221) may include other types of sensors, such as transmitters and receivers to measure resistivity, gamma ray detectors, etc. The sensors (221) may include hardware and/or software for generating different types of well logs (such as acoustic logs or density logs) that may provide well data about a wellbore, including porosity of wellbore sections, gas saturation, bed boundaries in a geologic formation, fractures in the wellbore or completion cement, and many other pieces of information about a formation. If such well data is acquired during drilling operations (i.e., logging-while-drilling), then the information may be used to make adjustments to drilling operations in real-time. Such adjustments may include rate of penetration (ROP), drilling direction, altering mud weight, and many others drilling parameters.

In some embodiments, acoustic sensors may be installed in a drilling fluid circulation system of a drilling system (200) to record acoustic drilling signals in real-time. Drilling acoustic signals may transmit through the drilling fluid to be recorded by the acoustic sensors located in the drilling fluid circulation system. The recorded drilling acoustic signals may be processed and analyzed to determine well data, such as lithological and petrophysical properties of the rock formation. This well data may be used in various applications, such as steering a drill bit using geosteering, casing shoe positioning, etc.

The control system (244) may be coupled to the sensor assembly (223) in order to perform various program functions for up-down steering and left-right steering of the drill bit (224) through the wellbore (216). More specifically, the control system (244) may include hardware and/or software with functionality for geosteering a drill bit through a formation in a lateral well using sensor signals, such as drilling acoustic signals or resistivity measurements. For example, the formation may be a reservoir region, such as a pay zone, bed rock, or cap rock.

Turning to geosteering, geosteering may be used to position the drill bit (224) or drill string (215) relative to a boundary between different subsurface layers (e.g., overlying, underlying, and lateral layers of a pay zone) during drilling operations. In particular, measuring rock properties during drilling may provide the drilling system (200) with the ability to steer the drill bit (224) in the direction of desired hydrocarbon concentrations. As such, a geosteering system may use various sensors located inside or adjacent to the drilling string (215) to determine different rock formations within a wellbore's path. In some geosteering systems, drilling tools may use resistivity or acoustic measurements to guide the drill bit (224) during horizontal or lateral drilling.

Turning to FIG. 2B, FIG. 2B illustrates some embodiments for steering a drill bit through a lateral pay zone using a geosteering system (290). As shown in FIG. 2B, the geosteering system (290) may include the drilling system (200) from FIG. 2A. In particular, the geosteering system (290) may include functionality for monitoring various sensor signatures (e.g., an acoustic signature from acoustic sensors) that gradually or suddenly change as a well path traverses a cap rock (230), a pay zone (240), and a bed rock (250). Because of the sudden change in lithology between the cap rock (230) and the pay zone (240), for example, a sensor signature of the pay zone (240) may be different from the sensor signature of the cap rock (230). When the drill bit (224) drills out of the pay zone (240) into the cap rock (230), a detected amplitude spectrum of a particular sensor type may change suddenly between the two distinct sensor signatures. In contrast, when drilling from the pay zone (240) downward into the bed rock (250), the detected amplitude spectrum may gradually change.

During the lateral drilling of the wellbore (216), preliminary upper and lower boundaries of a formation layer's thickness may be derived from a geophysical survey and/or an offset well obtained before drilling the wellbore (216). If a vertical section (235) of the well is drilled, the actual upper and lower boundaries of a formation layer (i.e., actual pay zone boundaries (A, A′)) and the pay zone thickness (i.e., A to A′) at the vertical section (235) may be determined. Based on this well data, an operator may steer the drill bit (224) through a lateral section (260) of the wellbore (216) in real time. In particular, a logging tool may monitor a detected sensor signature proximate the drill bit (224), where the detected sensor signature may continuously be compared against prior sensor signatures, e.g., of the cap rock (230), pay zone (240), and bed rock (250), respectively. As such, if the detected sensor signature of drilled rock is the same or similar to the sensor signature of the pay zone (240), the drill bit (224) may still be drilling in the pay zone (240). In this scenario, the drill bit (224) may be operated to continue drilling along its current path and at a predetermined distance (0.5 h) from a boundary of a formation layer. If the detected sensor signature is same as or similar to the prior sensor signatures of the cap rock (230) or the bed rock (250), respectively, then the control system (244) may determine that the drill bit (224) is drilling out of the pay zone (240) and into the upper or lower boundary of the pay zone (240). At this point, the vertical position of the drill bit (224) at this lateral position within the wellbore (216) may be determined and the upper and lower boundaries of the pay zone (240) may be updated, (for example, positions B and C in FIG. 2B). In some embodiments, the vertical position at the opposite boundary may be estimated based on the predetermined thickness of the pay zone (240), such as positions B′ and C′.

While FIGS. 2A, and 2B shows various configurations of components, other configurations may be used without departing from the scope of the disclosure. For example, various components in FIGS. 2A, and 2B may be combined to create a single component. As another example, the functionality performed by a single component may be performed by two or more components. (3000)

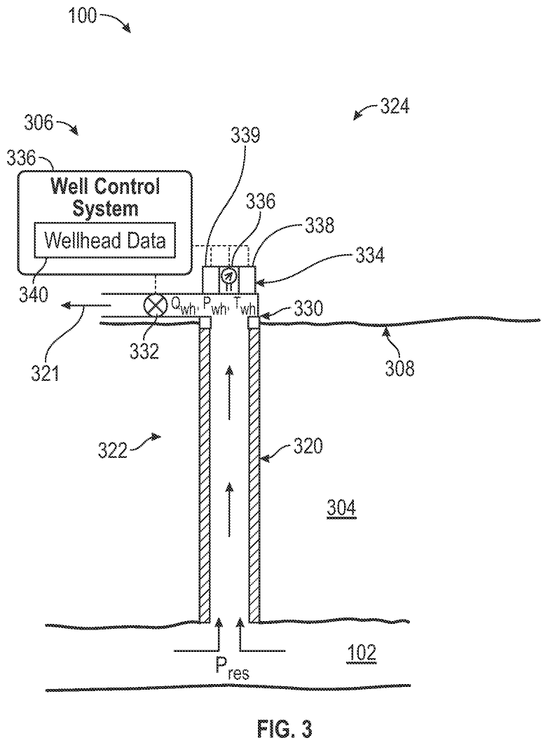

FIG. 3 illustrates a well environment (100) that includes a hydrocarbon reservoir (“reservoir”) (302) located in a sub surface hydrocarbon-bearing formation (“formation”) (304) and a well system (306). The hydrocarbon-bearing formation (304) may include a porous or fractured rock formation that resides underground, beneath the earth's surface (“surface”) (308). In the case of the well system (306) being a hydrocarbon well, the reservoir (302) may include a portion of the hydrocarbon-bearing formation (304). The hydrocarbon-bearing formation (304) and the reservoir (302) may include different layers of rock having varying characteristics, such as varying degrees of permeability, porosity, and resistivity. In the case of the well system (306) being operated as a production well, the well system (306) may facilitate the extraction of hydrocarbons (or “production”) from the reservoir (302).

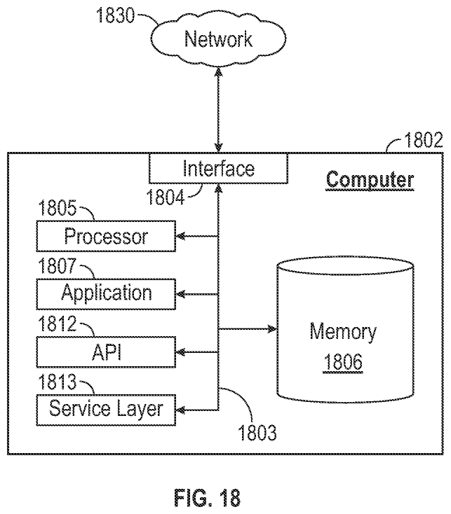

In some embodiments, the well system (306) includes a wellbore (320), a well sub-surface system (322), a well surface system (324), and a well control system (“control system”) (326). The control system (326) may control various operations of the well system (306), such as well production operations, well completion operations, well maintenance operations, and reservoir monitoring, assessment and development operations. In some embodiments, the control system (326) includes a computer system that is the same as or similar to that of computing system (1800) described below in FIG. 18 and the accompanying description.

The wellbore (320) may include a bored hole that extends from the surface (308) into a target zone of the hydrocarbon-bearing formation (304), such as the reservoir (302). An upper end of the wellbore (320), terminating at or near the surface (308), may be referred to as the “up-hole” end of the wellbore (320), and a lower end of the wellbore, terminating in the hydrocarbon-bearing formation (304), may be referred to as the “down-hole” end of the wellbore (320). The wellbore (320) may facilitate the flow of hydrocarbon production (“production”) (321) (e.g., oil and gas) from the reservoir (302) to the surface (308) during production operations, the injection of substances (e.g., water) into the hydrocarbon-bearing formation (304) or the reservoir (302) during injection operations, or the communication of monitoring devices (e.g., logging tools) into the hydrocarbon-bearing formation (304) or the reservoir (302) during monitoring operations (e.g., during in situ logging operations).

In some embodiments, during operation of the well system (306), the control system (326) collects and records wellhead data (340) for the well system (306). The wellhead data (340) may include, for example, a record of measurements of wellhead pressure (P_{wh}) (e.g., including flowing wellhead pressure), wellhead temperature (T_{wh}) (e.g., including flowing wellhead temperature), wellhead production rate (Q_{wh}) over some or all of the life of the well (306), and water cut data. In some embodiments, the measurements are recorded in real-time, and are available for review or use within seconds, minutes or hours of the condition being sensed (e.g., the measurements are available within 1 hour of the condition being sensed). In such an embodiment, the wellhead data (340) may be referred to as “real-time” wellhead data (340). Real-time wellhead data (340) may enable an operator of the well (306) to assess a relatively current state of the well system (306), and make real-time decisions regarding development of the well system (306) and the reservoir (302), such as on-demand adjustments in regulation of production flow from the well.

In some embodiments, the well surface system (324) includes a wellhead (330). The wellhead (330) may include a rigid structure installed at the “up-hole” end of the wellbore (320), at or near where the wellbore (320) terminates at the Earth's surface (308). The wellhead (330) may include structures for supporting (or “hanging”) casing and production tubing extending into the wellbore (320). Production (321) may flow through the wellhead (330), after exiting the wellbore (320) and the well sub-surface system (322), including, for example, the casing and the production tubing. In some embodiments, the well surface system (324) includes flow regulating devices that are operable to control the flow of substances into and out of the wellbore (320). For example, the well surface system (324) may include one or more production valves (332) that are operable to control the flow of production (334). For example, a production valve (332) may be fully opened to enable unrestricted flow of production (321) from the wellbore (320), the production valve (332) may be partially opened to partially restrict (or “throttle”) the flow of production (321) from the wellbore (320), and production valve (332) may be fully closed to fully restrict (or “block”) the flow of production (321) from the wellbore (320), and through the well surface system (324).

Keeping with FIG. 3, in some embodiments, the well surface system (324) includes a surface sensing system (334). The surface sensing system (334) may include sensors for sensing characteristics of substances, including production (321), passing through or otherwise located in the well surface system (324). The characteristics may include, for example, pressure, temperature and flow rate of production (321) flowing through the wellhead (330), or other conduits of the well surface system (324), after exiting the wellbore (320).

In some embodiments, the surface sensing system (334) includes a surface pressure sensor (336) operable to sense the pressure of production (351) flowing through the well surface system (324), after it exits the wellbore (320). The surface pressure sensor (336) may include, for example, a wellhead pressure sensor that senses a pressure of production (321) flowing through or otherwise located in the wellhead (330). In some embodiments, the surface sensing system (334) includes a surface temperature sensor (338) operable to sense the temperature of production (351) flowing through the well surface system (324), after it exits the wellbore (320). The surface temperature sensor (338) may include, for example, a wellhead temperature sensor that senses a temperature of production (321) flowing through or otherwise located in the wellhead (330), referred to as “wellhead temperature” (T_{wh}). In some embodiments, the surface sensing system (334) includes a flow rate sensor (339) operable to sense the flow rate of production (351) flowing through the well surface system (324), after it exits the wellbore (320). The flow rate sensor (339) may include hardware that senses a flow rate of production (321) (Q_{wh}) passing through the wellhead (330).

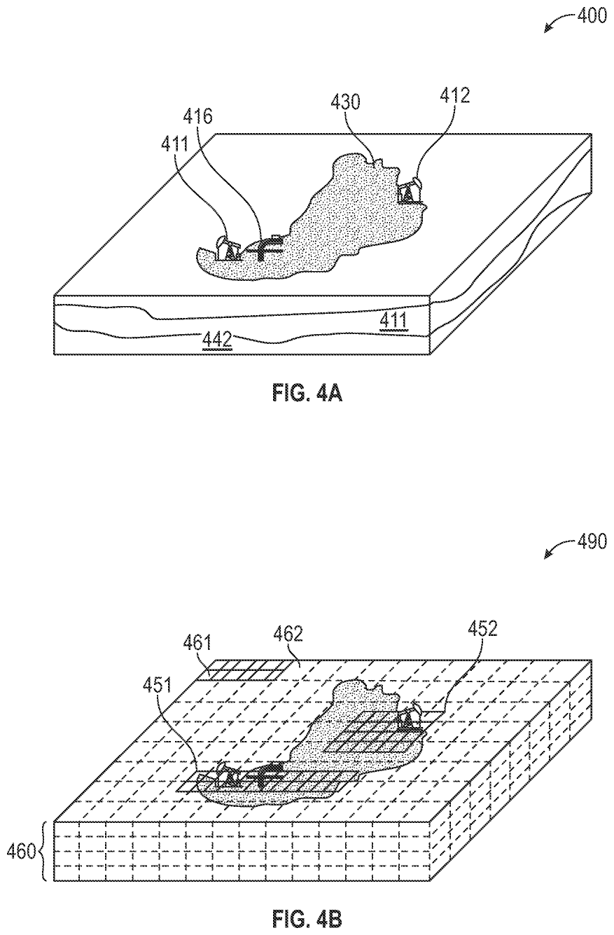

Turning to FIG. 4A, FIG. 4A shows a schematic diagram in accordance with one or more embodiments. More specifically, FIG. 4A shows a geological region (400) that may include one or more reservoir regions (e.g., reservoir region (430)) with various production wells (e.g., production well A (411), production well (412)). For example, a production well may be similar to the well system (306) described above in FIG. 3 and the accompanying description. Likewise, a reservoir region may also include one or more injection wells (e.g., injection well C (416)) that include functionality for enhancing production by one or more neighboring production wells. As shown in FIG. 4A, wells may be disposed in the reservoir region (430) above various subsurface layers (e.g., subsurface layer A (441), subsurface layer B (442)), which may include hydrocarbon deposits. In particular, production data and/or injection data may exist for a particular well, where production data may include data that describes production or production operations at a well, such as wellhead data (340) described in FIG. 30 and the accompanying description.

Now turning to FIG. 4B, FIG. 4B shows a schematic diagram in accordance with one or more embodiments. More specifically, FIG. 4B shows a reservoir grid model (490) that corresponds to the geological region (400) from FIG. 4A. More specifically, the reservoir grid model (490) includes grid cells (461) that may refer to an original cell of a reservoir grid model as well as coarse grid blocks (462) that may refer to an amalgamation of original cells of the reservoir grid model. For example, a grid cell may be the case of a 1×1 block, where coarse grid blocks may be of sizes 2×2, 4×4, 8×8, etc. Both the grid cells (461) and the coarse grid blocks (462) may correspond to columns for multiple model layers (460) within the reservoir grid model (490).

Prior to performing a reservoir simulation, local grid refinement and coarsening (LGR) may be used to increase or decrease grid resolution in a certain area of reservoir grid model. For example, various reservoir properties, e.g., permeability, porosity or saturations, may correspond to a discrete value that is associated with a particular grid cell or coarse grid block. However, by using discrete values to represent a portion of a geological region, a discretization error may occur in a reservoir simulation. Thus, finer grids may reduce discretization errors as the numerical approximation of a finer grid is closer to the exact solution, however through a higher computational cost. As shown in FIG. 4B, for example, the reservoir grid model (490) may include various fine-grid models (i.e., fine-grid model A (451), fine-grid model B (452)), that are surrounded by coarse block regions. Likewise, the original reservoir grid model without any coarsening may also be a fine-grid model. In some embodiments, a reservoir grid model (or multiple reservoir grid models) may be used to preform reservoir simulations.

In some embodiments, a reservoir simulator (160) comprises functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator may be used to predict changes in fluid flow, including fluid flow into well penetrating the reservoir as a result of planned well drilling, and fluid injection and extraction. For example, the reservoir simulator may be used to predict changes in hydrocarbon production rate that would result from the injection of water into the reservoir from wells around the reservoirs periphery.

The reservoir simulator may use a reservoir model that contains a digital description of the physical properties of the rocks as a function of position within the reservoir and the fluids within the pores of the porous, permeable reservoir rocks at a given time. In some embodiments, the digital description may be in the form of a dense 3D grid with the physical properties of the rocks and fluids defined at each node. In some embodiments, the 3D grid may be a cartesian grid, while in other embodiments the grid may be an irregular grid.

The physical properties of the rocks and fluids within the reservoir may be obtained from a variety of geological and geophysical sources. For example, remote sensing geophysical surveys, such as seismic surveys, gravity surveys, and active and passive source resistivity surveys, may be employed. In addition, data collected such as well logs, core data, production data as previously discussed, acquired in wells penetrating the reservoir may be used to determine physical and petrophysical properties along the segment of the well trajectory traversing the reservoir. For example, porosity, permeability, density, seismic velocity, and resistivity may be measured along these segments of wellbore. In accordance with some embodiments, remote sensing geophysical surveys and physical and petrophysical properties determined from well logs may be combined to estimate physical and petrophysical properties for the entire reservoir simulation model grid.

Reservoir simulators solve a set of mathematical governing equations that represent the physical laws that govern fluid flow in porous, permeable media. For example, the flow of a single-phase slightly compressible oil with a constant viscosity and compressibility the equations capture Darcy's law, the continuity condition and the equation of state and may be written as:

$${∇}^{2} p ( x , t ) = \frac{ϕ μ {c}_{t}}{k} \frac{\partial p ( x , t )}{\partial t} \qquad ( 1 )$$

where p represents fluid in the reservoir, x is a vector representing spatial position and t represents time. φ, μ, and cₜ, k represent the physical and petrophysical properties of porosity, fluid viscosity, total combined rock and fluid compressibility, and permeability, respectively. ∇² represents the spatial Laplacian operator.

Additional, and more complicated equations are required when more than one fluid, or more than one phase, e.g. liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite element methods, or discrete Galerkin methods.

Embodiments disclosed herein may relate to computerized simulation of hydrocarbon reservoirs in the earth, and in particular to simulation of flow profiles along wells in a reservoir.

Well models have played an important role in numerical reservoir simulation. Well models have been used to calculate oil, water and gas production rates from wells in an oil and gas reservoirs. If the well production rate is known, they are used to calculate the flow profile along the perforated interval of the well. With the increasing capabilities for measuring flow rates along the perforated intervals of a well, a proper numerical well model is necessary to compute the correct flow profile to match the measurements in a reservoir simulator.

It is well known that simple well models such as explicit or semi-implicit models could be adequate if all reservoir layers communicated vertically for any vertical wells in a reservoir simulator. For these models, well production rate is allocated to the perforations in proportion to the layer productivity indices (or total mobility). Therefore, the calculations are simple and computationally inexpensive. The structure of the resulting coefficient matrix for the reservoir unknowns remains unchanged. Specifically, the coefficient matrix maintains a regular sparse structure. Therefore, any such sparse matrix solver could be used to solve the linear system for the grid block pressures and saturations for every time step for the entire reservoir simulation model.

However, for highly heterogeneous reservoirs with some vertically non-communicating layers, the above-mentioned well models cannot produce the correct physical solution. Instead, they produce incorrect flow profiles and, on some occasions, cause simulator convergence problems.

With the increasing sophistication of reservoir models, the number of vertical layers has come to be in the order of hundreds to represent reservoir heterogeneity. Fully implicit, fully coupled well models with simultaneous solution of reservoir and well equations have been necessary to correctly simulate the flow profiles along the well and also necessary for the numerical stability of the reservoir simulation. In order to solve the fully coupled system, generally, well equations are eliminated first. This creates an unstructured coefficient matrix for the reservoir unknowns to be solved. Solutions of this type of matrices require specialized solvers with specialized pre-conditioners. For wells with many completions and many wells in a simulation model, this method has become computationally expensive in terms of processor time.

In the oil and gas industry many systems (such as drilling systems, well systems, reservoir simulations systems, data acquisition systems, data processing systems, etc.) and techniques (such as Artificial Intelligence, Machine Learning, Deep Learning, modeling, inversion, imaging, etc.) rely, at least in part, on processes that may be conducted on a graphical processing unit (GPU). In order to make computations using data sets and models that can vary widely in size and complexity, it may be desirable to ensure that a GPU architecture, data layout, pre-conditioning, and memory access are optimally managed.

It is known that linear systems that arise from reservoir simulations may be solved with stiff and iterative linear solvers, such as a generalized minimal residual (GMRES) method, which benefit greatly when combined with pre-conditioners. One very strong pre-conditioner is a linear solver where the lines with the strongest connectivity in the reservoir may be solved using direct methods. The data of each strongly connected line may be represented as a tridiagonal matrix linear system which may be solved using the Thomas algorithm. Solving the tridiagonal linear system using the Thomas algorithm involves two primary passes often called the “forward” and “backward” passes. This process maybe computationally expensive and inefficient. Accordingly, there exists a need to implement methods for making these computations more efficient. Embodiments disclosed herein implement a methodology that may greatly improve the runtime, when compared to existing methods, of the primary passes of Thomas' algorithm when the implementation is executed on a GPU platform. The methodology implements a novel data layout that combines both data dependency and the GPU threads memory access patterns.

For example, by way of introduction, the equations and numerical processes associated with a sequential fully implicit well model for reservoir simulation are described below. Reservoir simulation is a mathematical modeling science for reservoir engineering. The fluid flow inside the oil or gas reservoir (porous media) is described by a set of partial differential equations. These equations describe the pressure (energy) and temperature distribution, oil, water and gas velocity distribution, fractional volumes (saturations) of oil, water, gas at any point in reservoir at any time during the life of the reservoir that produces oil, gas, and water. Note that the local or global quantity of oil, gas, or water may be zero such that wells described herein are not limited to only those possessing oil, gas, and water. Further, it is well understood that additional constituents such as solid particulates (e.g., sand) and other liquids and gases (e.g., chemical surfactants used during the drilling and/or production processes) may be present in a reservoir and produced through a well. Generally, fluid flow inside the reservoir is described by tracing the movement (e.g., convection, diffusion) of the components of the mixture. Amounts of components such as liquid hydrocarbons, methane, ethane, CO₂, nitrogen, H₂5 and water may be expressed either in mass unit or moles.

Since these equations and associated thermodynamic and physical laws describing the fluid flow are complicated, they can only be solved on digital computers to obtain pressure distribution, velocity distribution, and fluid saturation or the amount of component mass or mole distribution within the reservoir. As such solving these equations for reservoir models of a useful and realistic size using only mental processes or manual computation are completely infeasible in any reasonable timeframe. Generally, these equations and physical laws describes the properties of pressure, temperature, fluid flow velocity, and saturation spatially throughout a spatial region (e.g., 3D volume, 2D plane) over a temporal period using boundary and initial conditions, respectively. An analytical solution does not exist for such a system of equations and thus these equations must be solved numerically. Numerical solutions require that the reservoir be discretized, both spatially and temporally, into computational elements (spatially, into cells or grid blocks, and temporally, into time steps) throughout the reservoir volume. The spatial discretization is typically performed using a Cartesian coordinate system, but may use other coordinate systems and/or irregular grids. For example, for a 3D volume, coordinates may be given with respect to an x-axis, y-axis, and z-axis that are mutually orthogonal. The temporal discretization, or time step, may be on the order of days or months. For each element, the unknowns (pressure, velocity, volume fractions, etc.) are determined by solving the complicated mathematical equations.

The equations describing a general reservoir simulation model and indicating the well terms which are of interest in connection with the present invention are set forth below in Equation 2:

$${Δ}_{x} {\sum }_{j = 1}^{{n}_{p}} {T}_{x} {ρ}_{ij} {λ}_{j} Δ {Φ}_{j} + {Δ}_{y} {\sum }_{j = 1}^{{n}_{p}} {T}_{y} {ρ}_{ij} {λ}_{j} Δ {Φ}_{j} + {Δ}_{z} {\sum }_{j = 1}^{{n}_{p}} {T}_{z} {ρ}_{ij} {λ}_{j} Δ {Φ}_{j} + {\sum }_{j = 1}^{{n}_{p}} {q}_{ij} = \frac{{Δ}_{t} {n}_{i}}{Δ t} \qquad ( 2 )$$

$$i = 1 , … {n}_{c} , …$$

where Δₓ is the difference operator in the x direction, Tₓ, T_{y}, T_{z} are the rock transmissibilities in the x, y and z directions as defined in Equation 12 below, j is used to index individual fluid phases, nₚ is the total number of fluid phases (usually 3 fluid phases: oil, water, and gas), ρᵢⱼ is the density of component i in the fluid phase j, λⱼ is the mobility of the phase j (Equation 6), and Φⱼ is the fluid potential (datum corrected pressure) of fluid phase j. Continuing, Δₓ is the difference operator in x direction, Δ_{y} is the difference operator in y direction, and Δ_{z} is the difference operator in z direction of the reservoir, qᵢₖ is the well term (source or sink) for the component i for grid block (cell) k, Δₜ is the difference operator in time domain, nᵢ is the total number of moles for component i, and n_{c} is the total number of components in the fluid system. Typical components include, without limitation, liquid hydrocarbons; methane; ethane; propane; CO₂; H₂S; and water. The number of components depends on the hydrocarbon water system available for the reservoir of interest. Typically, the number of components ranges from 3 to 10. Equation 2 combines the continuity equations and momentum equations.

In Equation 2, qᵢₖ is the well perforation rate at location xₖ, yₖ, zₖ for component i and k is the grid block (cell) number. Again, the calculation of this term from the specified production rates at the well head is the subject of the present invention.

In addition to the differential equations in Equation 2, a pore volume constraint at any point (element) in the reservoir must be satisfied:

$${V}_{p} ( P ( x , y , z ) ) = {\sum }_{j = 1}^{{n}_{p}} \frac{{N}_{j}}{{ρ}_{j}} \qquad ( 3 )$$

where Vₚ is the grid block pore volume, P(x, y, z) is the fluid pressure at point x, y, z, Nⱼ is the total number of moles in fluid phase j, and ρⱼ is the density of fluid phase j.

There are n_{c}+1 equations in Equations 2 and 3, and n_{c}+1 unknowns. These equations may be solved simultaneously with thermodynamics phase constraints for each component i by:

fᵢ^{v}(nᵢᵥ,n₁,n₂, . . . ,n_{c},P,T)=fᵢ^{L}(n_{iL},n₁,n₂, . . . ,n_{c},P,T) (4)

where fᵢ^{V} is the component fugacity, superscript V stands for the vapor phase, L stands for the liquid phase, nᵢ is the total number of moles of component i, P is the pressure and T represents the temperature.

In the fluid system in a reservoir typically there are three fluid phases: oil phase, gas phase, and water phase. Each fluid phase may contain different amounts of components described above based on the reservoir pressure and temperature. The fluid phases are described by the symbol j. The symbol nₚ is the total number of phases (sometimes it could be 1 (oil); 2 (oil and gas or oil and water); or 3 (oil, water, and gas)). The number of phases nₚ varies based on reservoir pressure (P) and temperature (T). The number of phases and fraction of each component in each phase n_{i,j} as well as the phase density ρᵢ and ρᵢⱼ are determined from Equation 4. In Equation 4, V stands for the vapor (gas) phase and L stands for liquid phase (oil or water).

Total number of moles in a fluid phase j is defined by:

Nⱼ=Σᵢ₌₁ⁿ^{_{c}}n_{i,j} (5)

Total component moles are defined by:

Nᵢ=Σⱼ₌₁ⁿ^{ₚ}n_{i,j}. (6)

Phase mobility in Equation 2, the relation between the phases, definition of fluid potential and differentiation symbols are defined in Equations 7 through 10. Below, in Equation 7, the numerator represents the phase relative permeability and the denominator the phase viscosity:

λᵢ=k_{r,j}/μⱼ. (7)

The capillary pressure between the phases may be defined by Equation 8 with respect to the phase pressures as

P_{c}(sⱼ,s_{j′})=Pᵢ−P_{j′}. (8)

The fluid potential for phase j is defined by:

Φⱼ=Pⱼ−gρⱼg. (9)

Discrete differentiation operators in the x, y, and z directions are defined by:

$${Δ}_{x} = \frac{δ}{δ x} , \qquad ( 10 )$$

$${Δ}_{y} = \frac{δ}{δ y} ,$$

$${Δ}_{z} = \frac{δ}{δ z} ,$$

$${Δ}_{t} = \frac{δ}{δ t}$$

where Δ denotes the discrete difference symbol.

Equation 2, together with the constraints and definitions in Equations 3 through 10, are written for every grid block (cell) in a reservoir simulator using a control volume finite difference method (some of the grid blocks may additionally include wells). The resulting equations are solved simultaneously. This is done to find the distribution of n1 (x, y, z, and t) and P (x, y, z, and t) given the well production rates for each well from which the component rates in Equation 2 are calculated according to the present invention using the new well model formulation. In order to solve Equations 2 and 3, reservoir boundaries in (x, y, z)-space, rock property distribution P(x, y, z), and fluid properties and saturation dependent data are entered into the simulation.

The methodology of a vertical well model of a reservoir simulator is presented below. For simplicity, the following representation is based on a simple fluid system in the form of flow of a slightly compressible single phase oil flow inside the reservoir. However, it should be understood that the present invention may be readily applied to more complex reservoirs and can be used for any number of wells and fluid phases in a regular reservoir simulation model.

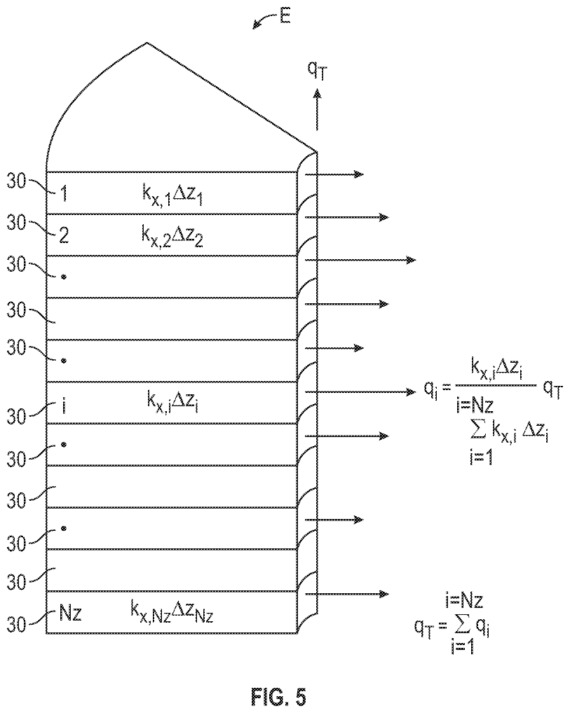

It is well known that simple vertical well models such as explicit or semi-implicit models have been generally adequate if all reservoir layers communicate vertically. As shown in FIG. 5, an explicit well model E is composed of a number N_{z} of reservoir layers 30 in vertical flow communication, each layer having a permeability k_{x,i} (here i represents the layer number, not a component) and a thickness Δzᵢ and a perforation layer rate qᵢ defined as indicated in FIG. 5. The total production rate q_{T} for the explicit model E is then the sum of the individual production rates qᵢ for the N_{z} layers of the explicit model as indicated by the Equation in the same Figure.

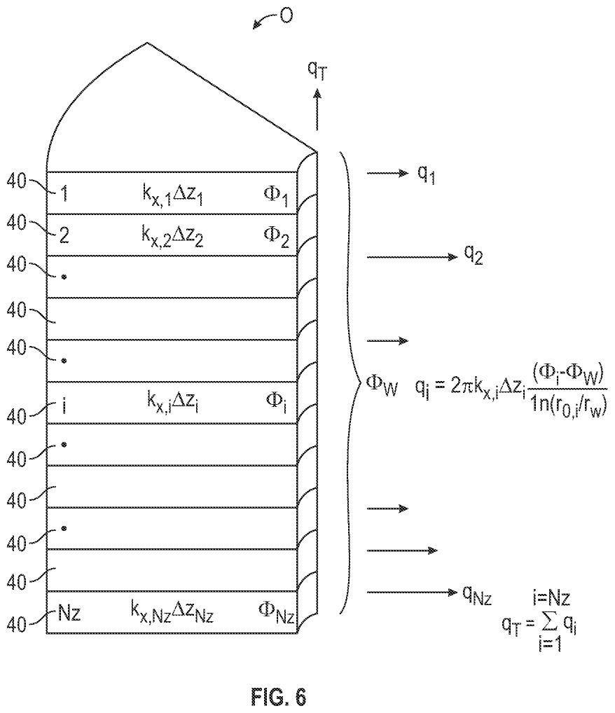

FIG. 6 depicts a more comprehensive well model. The well model according to FIG. 6 is called a coupled reservoir well model. The associated numerical solution is referred to fully implicit, fully coupled and simultaneous solution. A fully implicit fully coupled reservoir well model produces correct flow profile along the perforated well interval, as will be described. As shown in FIG. 6 a reservoir model O is composed of a number z of i individual layers 1 through N_{z}, each with a permeability k_{x,i} and a thickness Δzᵢ and a potential Φᵢ defined as indicated in FIG. 6, and upper and lower layers 40 of relatively low permeability, and with vertical flow, located above and below, respectively, an isolated high permeability layer 42 with no vertical flow communication with adjacent layers. As can be seen in FIG. 6, the production rates qᵢ for layer i of the model O is indicated by the expression set forth in FIG. 6.

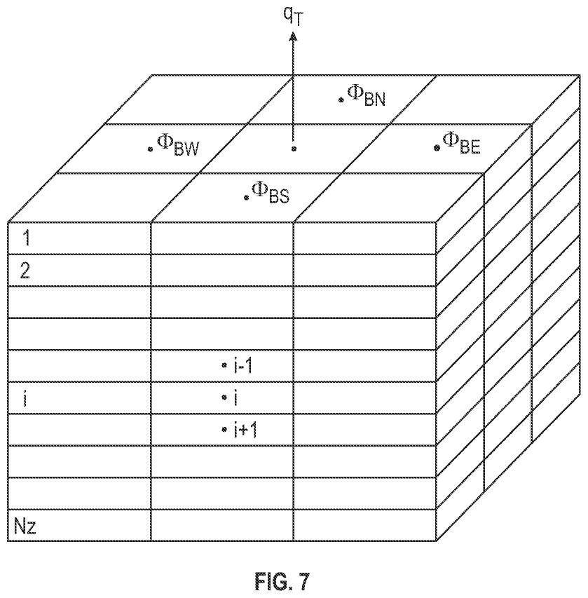

FIG. 7 illustrates the finite difference grid G used in this description for a vertical well model. As seen, a well is located at the center of the central cell in vertical directions. The models set forth below also contemplate that the well is completed in the vertical N_{z} directions, and the potentials in the adjacent cells Φ_{BW}, Φ_{BE}, Φ_{BN}, Φ_{BS} , are constants and known from the simulation run (previous time step or iteration value). Here subscript B refers to “Boundary”, W indicates West neighbor, E stands for East neighbor, and N and S stand for North and South, respectively. Again, Φ describes the fluid potential (datum corrected pressure).

As can be seen in FIG. 7, the well is penetrating a number of reservoir layers in the vertical direction represented by the index i, for i=1, 2, 3, . . . N_{z}, where N_{z} is the total number of vertical layers in the reservoir model. For each layer i, there are four neighboring cells at the same areal plane (x, y). These neighboring cells are in the East-West (x direction) and North-South (y direction).

The potential Φ of the East, West, North and South neighbors are known from the simulator time step calculations, and those potentials are set in that they are assumed not to change over the simulator time step. The vertical potential variations at the well location are then considered, but neighbor potentials which can vary in the vertical direction but are assumed to be known.

The steady state volume balance equation for the cell i in FIG. 7 is as follows:

T_{wi}(Φ_{BW}−Φᵢ)+T_{Ei}(Φ_{BE}−Φᵢ)+T_{Ni}(Φ_{BN}−Φᵢ)+T_{Si}(Φ_{BS}−Φᵢ)+T_{Ui}(Φᵢ₋₁−Φᵢ)+T_{Di}(Φᵢ₊₁−Φᵢ)−qᵢ=0. (11)

In Equation 11, T represents the transmissibility between the cells. The subscripts W, E, N, and S denote West, East, South and North directions, and i represents the cell index.

The transmissibilities between cells for three directions are defined as:

$${T}_{W i} = {k}_{x , i - \frac{1}{2}} \frac{Δ {y}_{i} Δ {z}_{i}}{0.5 ( Δ {x}_{i - 1} + Δ {x}_{i} )} , \qquad ( 12 )$$

$${T}_{E i} = {k}_{x , i + \frac{1}{2}} \frac{Δ {y}_{i} Δ {z}_{i}}{0.5 ( Δ {x}_{i + 1} + Δ {x}_{i} )} ,$$

$${T}_{N i} = {k}_{y , i - \frac{1}{2}} \frac{Δ {x}_{i} Δ {z}_{i}}{0.5 ( Δ {y}_{i - 1} + Δ {y}_{i} )} ,$$

$${T}_{S i} = {k}_{y , i - \frac{1}{2}} \frac{Δ {x}_{i} Δ {z}_{i}}{0.5 ( Δ {y}_{i - 1} + Δ {y}_{i} )} ,$$

$${T}_{U i} = {k}_{z , i - \frac{1}{2}} \frac{Δ {y}_{i} Δ {z}_{i}}{0.5 ( Δ {z}_{i - 1} + Δ {z}_{i} )} ,$$

$${T}_{D i} = {k}_{z , i - \frac{1}{2}} \frac{Δ {y}_{i} Δ {z}_{i}}{0.5 ( Δ {z}_{i - 1} + Δ {z}_{i} )} ,$$

In the above Equations 12, Δxᵢ is the grid block size (cell size) in the x direction for the grid block (cell) number i. Similarly, Δyᵢ is the grid block size (cell size) in the y direction for the grid block (cell) number i, and Δzᵢ is the grid block size (cell size) or grid layer thickness in the z direction for the grid block (cell) number i. k_{z,i-1/2} is the vertical permeability at the interface of the cells i and i−1 . Similarly, k_{z,i+1/2} is the vertical permeability at the interface of the cells i and i+1. As seen in FIG. 5, the cell i is at the center, i+½ interface between the cell i and i+1. For convenience, the subscript j is dropped while expressing East-West flow. Similarly, (i,j−1) is the north neighbor of the central cell (i,j). Therefore, the notation (i,j−½) is the interface between the central cell and north neighbor in the y direction.

The same notation is carried out for the South neighbor: (i,j+½) denotes the interface between the central cell (i,j) and South neighbor (i,j+1) in they direction. For convenience in the above equations, subscript i is dropped while expressing y (or j) direction. As is evident, transmissibilities in Equation 12 are defined in a similar manner.

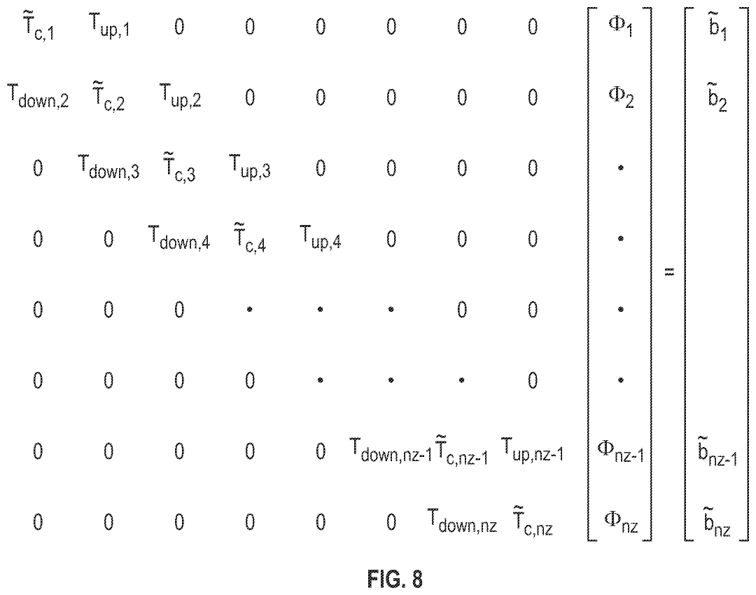

In FIG. 8, the diagonal terms \tilde{T}_{c,i} are defined by:

\tilde{T}_{c,i}=(T_{Up,i}+T_{Down,i}+T_{W,i}+T_{E,i}+T_{N,i}+T_{S,i}+PIᵢ). (13)

The transmissibilities between cells for three directions are as defined in Equations 12, as set forth above. The terms \tilde{b}ᵢ in the FIG. 8 (right-hand side) are expressed by:

\tilde{b}ᵢ=−(PIᵢΦ_{W}+T_{w,i}Φ_{BW}+T_{w,i}Φ_{BE}+T_{w,i}Φ_{BN}+T_{w,i}Φ_{BS}) (14)

where i=1, 2, . . . , N_{z}, with N_{z} again being the total number of grids in the vertical directions, the number of vertical layers. In this representation of Equation 14, PIᵢ is the layer productivity index and is defined by:

$$P {I}_{i} = \frac{2 π {k}_{x , i} Δ {z}_{i}}{ln ( {r}_{o , i} / {r}_{w} )} , \qquad ( 15 )$$

and the Φ_{B} potential terms are the known boundary potentials at boundaries of the neighbor cells to the West, East, North and South of the central cell. As is conventional, the terms, cell and grid block are used interchangeably.

Conventional well models can be generally classified in three groups: (a) the Explicit Well Model; (b) the Bottom Hole Pressure Specified Well Model; and (c) the Fully Implicit Well Model (Aziz K, Settari A, Petroleum Reservoir Simulation, Applied Science Publishers Ltd, London 1979). A brief review of an explicit well model is presented below, however, one with ordinary skill in the art will recognize that the methods and systems disclosed herein may be readily applied to any other well model without limitation.

For an explicit well model, the source term qi in Equation 11 is defined by:

$${q}_{i} = \frac{{k}_{x , i} Δ {z}_{i}}{{Σ}_{i = 1}^{i = {N}_{z}} {k}_{x , i} Δ {z}_{i}} q r \qquad ( 16 )$$

where qᵢ is the production rate for cell (grid block) i where the well is going through and perforated. Substituting Equation 16 into Equation 11 for cell i results in

$${T}_{Up , i} {Φ}_{i - 1} + {T}_{C , i} {Φ}_{i} + {T}_{D o w n , i} {Φ}_{i + 1} = {b}_{i} , \qquad ( 17 )$$

$$where$$

$${T}_{c , i} \pm ( {T}_{Up , i} + {T}_{D o w n , i} + {T}_{W i} + {T}_{E i} + {T}_{N i} + {T}_{S i} ) \qquad ( 18 a )$$

$$and$$

$${b}_{i} = \frac{{k}_{x , i} Δ {z}_{i}}{{Σ}_{i = 1}^{i = {N}_{z}} {k}_{x , i} Δ {z}_{i}} q r - ( {T}_{Wi} {Φ}_{B W} + {T}_{E i} {Φ}_{BE} + {T}_{N i} {Φ}_{BN} + {T}_{S i} {Φ}_{B S} ) . \qquad ( 18 b )$$

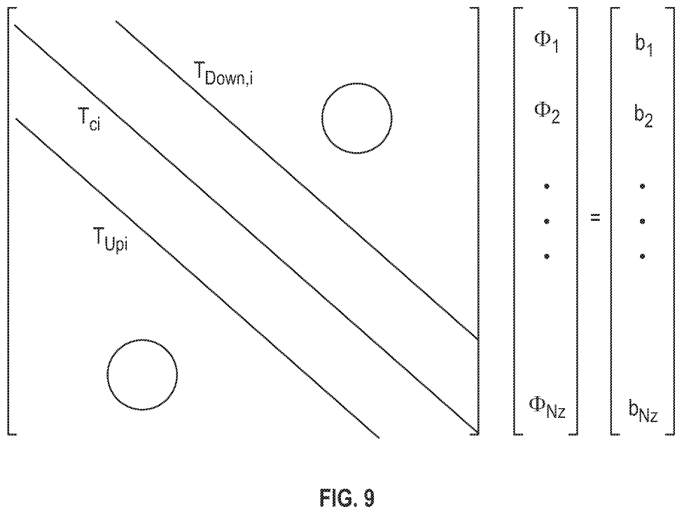

Writing Equation 17 for all the cells i=1 . . . N_{z} around the well for the well cells only results in a linear system of equations with a tridiagonal coefficient matrix of the type illustrated in FIG. 9, which can be written in matrix vector notation as below:

AA_{RR}\vec{Φ}_{R}=\vec{b}_{R}. (19)

In Equation 19, A_{RR} is a N_{z}×N_{z} tridiagonal matrix, and \vec{Φ}_{R} and \vec{b}_{R} are N_{z}×1 vectors. Equation 19 is solved by computer processing for the reservoir unknown potentials Φ_{R} grid blocks where well is going through by a tridiagonal linear system solver such as the Thomas algorithm.

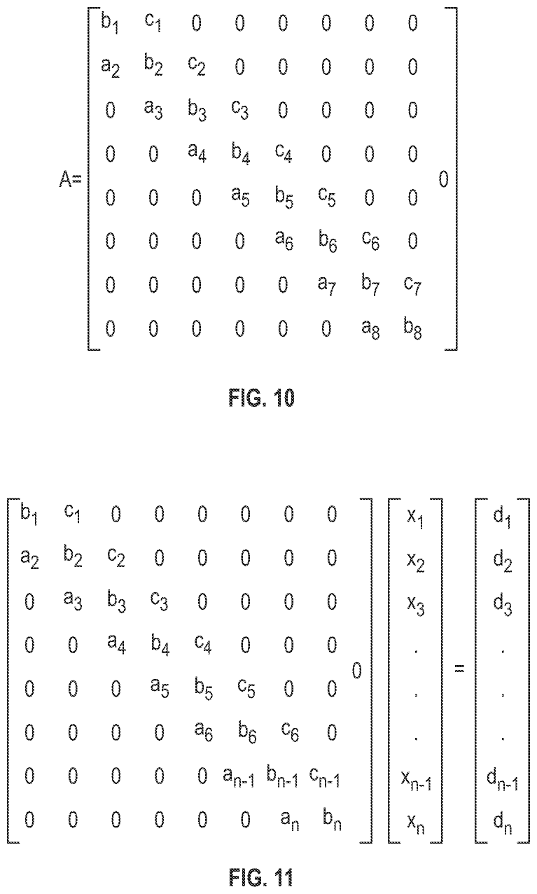

Tridiagonal matrices are the matrices with only three diagonals in the middle, with real or complex number as the entries in the diagonals. These diagonals are called “lower diagonal”, “central diagonal” and “upper diagonal”. The remaining elements or entries of a tridiagonal matrix are zeros. For example, FIG. 10 illustrates a tridiagonal matrix A of 8×8 matrix dimensions (or order n=8). In the FIG. 10, elements of A; the i^{th} element of A, namely a_{i=1 . . . 8} represents the lower diagonal; b_{i=1 . . . 8} the central diagonal; and c_{i=1 . . . 8} the upper diagonal elements.

Thus, the solution for xᵢ as shown in FIG. 11 is achieved by solving the matrix relationships of Equations 20a through 20e as follows:

$${c}_{i}^{′} = \{ \begin{matrix}\frac{{c}_{i}}{{b}_{i}} ; & i = 1 \\ \frac{{c}_{i}}{{b}_{i} - {a}_{i} {c}_{i - 1}^{′}} & i = 2 , 3 , … , n - 1\end{matrix} \qquad ( 20 a )$$

$${b}_{i}^{′} = 1 ; i = 1 , 2 , … , n \qquad ( 20 b )$$

$${d}_{i}^{′} = \{ \begin{matrix}\frac{{d}_{i}}{{b}_{i}} ; & i = 1 \\ \frac{{d}_{i} - {a}_{i} {d}_{i - 1}^{′}}{{b}_{i} - {a}_{i} {c}_{i - 1}^{′}} ; & i = 2 , 3 , … , n - 1\end{matrix} \qquad ( 20 c )$$

$${x}_{n} = {d}_{n}^{′} \qquad ( 20 d )$$

$${x}_{i} = {d}_{i}^{′} - {c}_{i}^{′} {x}_{i + 1} ; i = n - 1 , n - 2 , … , 1 \qquad ( 20 e )$$

As described above, in the oil and gas industry many systems (such as drilling systems, well systems, reservoir simulations systems, data acquisition systems, data processing systems, etc.) and techniques (such as Artificial Intelligence, Machine Learning, Deep Learning, modeling, inversion, imaging, etc.) may rely, at least in part, on processes that may be conducted on a graphical processing unit (GPU), such as those that implement the Thomas algorithm to solve tridiagonal systems as exemplified in Equation 19 and corresponding discussion tridiagonal matrices and systems. In order to make computations using data sets and models that can vary widely in size and complexity it may be desirable ensure that a GPU architecture, data layout, pre-conditioning and memory access are optimally managed.

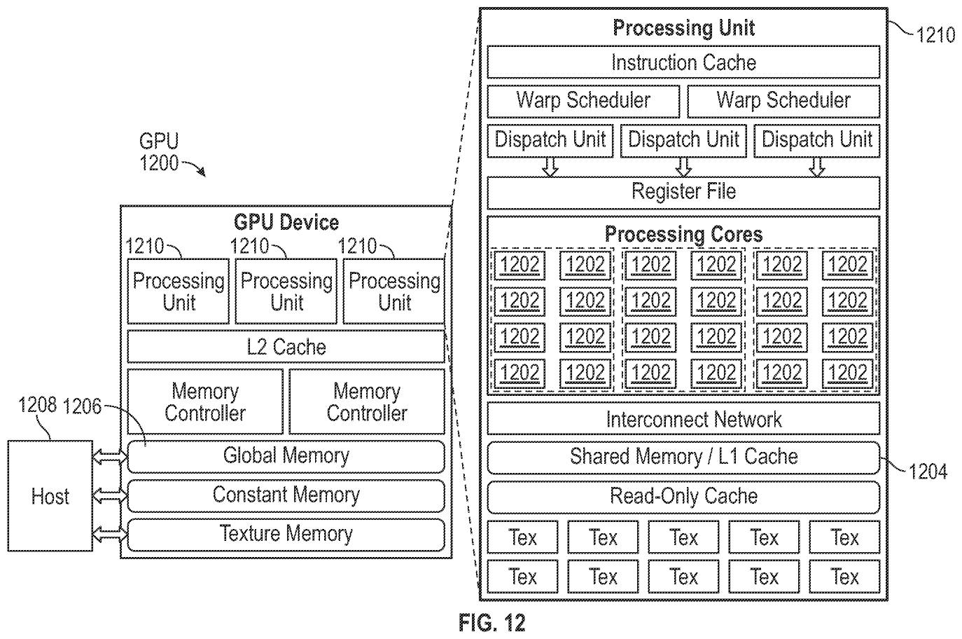

FIG. 12 illustrates an exemplary GPU schematic. Graphics Processing Units (GPUs) (1200) may be designed to handle specialized computations. GPUs may handle parallel computations much faster than CPUs. A GPU may be made of multiple processing units (1210) each including processing cores (1202) and a variety of other components such as schedulers, memory, and other components. The parallelization of computations may be implemented in such a way that a kernel executes a set of computations on data arranged in grids which may be subdivide into blocks and further subdivided into threads. Each thread may complete the assigned computations on a subset of the dataset on its own GPU processing core (1202). After the computations of each thread are completed, they may be combined back into blocks and then into grids and the completed data set is reassembled after the end of all the computations.

Continuing with FIG. 12, each element of the computation may be assigned to a memory level. A thread may have a dedicated local memory which cannot be accessed by other threads. Blocks may be assigned to a shared memory (1204). Finally, grids may be assigned to global memory (1206) on the CPU. Memory may also be accessed by the GPU on a host (1208) device or network.

The organization and arrangement in memory on a processing unit or on the GPU device memory or even the host memory may influence the efficiency with which computations are completed.

In one embodiment a data layout may be implemented that arranges linear data in GPU memory in a way that maximizes cache (e.g., shared memory) use and minimizes access to the GPU global memory. Implementing the data layout may accelerate problem solution compared to standard layouts used in most existing implementations for achieving the same objective.

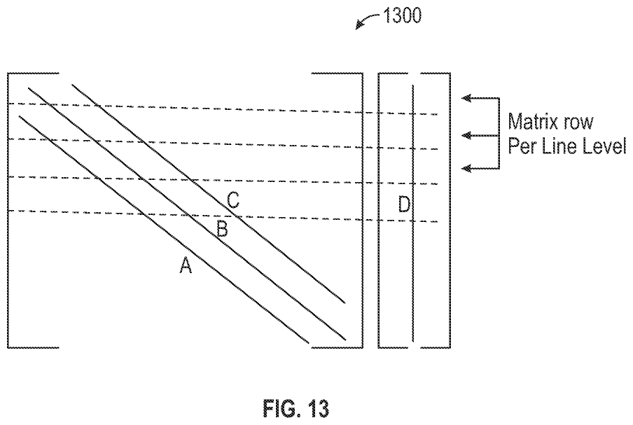

FIG. 13 depicts line data as a tridiagonal matrix system. The tridiagonal matrix system for each line consists of four main data arrays. The arrays may be denoted as A, B, C, and D as shown in FIG. 13. Each level of each line will have an entry in A, B, C, and D. For example, if there were 5 lines each of length 10, each of the resulting arrays will have 5×10 entries.

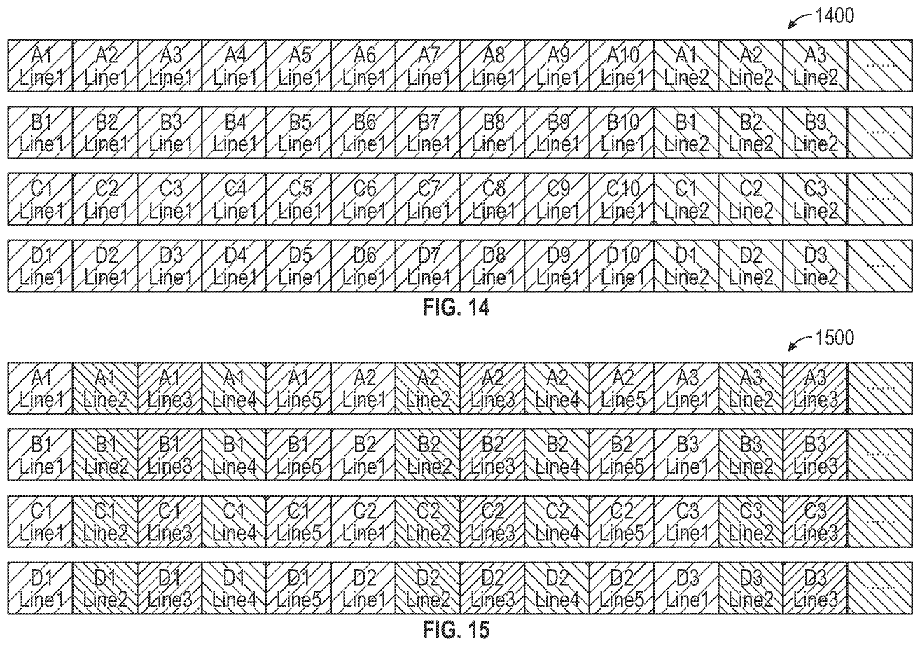

FIG. 14 demonstrates the natural alignment of the Thomas algorithm data in memory. The natural alignment used in existing implementations may arrange the data in a line-based storage in memory, i.e., a line-based data layout (1400). Such natural alignment may follow the domain of dependency and may be good for the CPU implementations of the Thomas algorithm.

FIG. 15 illustrates a level-based data layout (1500) in accordance with one or more embodiments of the instant disclosure. In this arrangement arrays A, B, C, and D are stored in a level-based storage in GPU memory. For example, array A of level 1 for each line is stored followed by A for level 2 for each line and so on.

In general, in the Thomas algorithm each line is solved level by level. That is, in series the forward pass of the algorithm each level 2 of any line cannot be worked on until level 1 is complete. Similarly, in the backward pass, level 1 work of any line cannot be worked on until level 2 of the same line is complete. This serial nature of the Thomas algorithm combined with the fact that each thread (or a series of threads) in a GPU warp will be working on a line and given the way GPU global memory is accessed the implementation of the a line-based data layout (1400) is not optimal. Rather, the serial nature is exploited by the level-based data layout (1500) of the instant disclosure by reducing the frequency that GPU threads may need to fetch data from GPU global memory. Thus, the level-based data layout provides enhanced GPU performance for the Thomas algorithm solution for tridiagonal matrix systems.

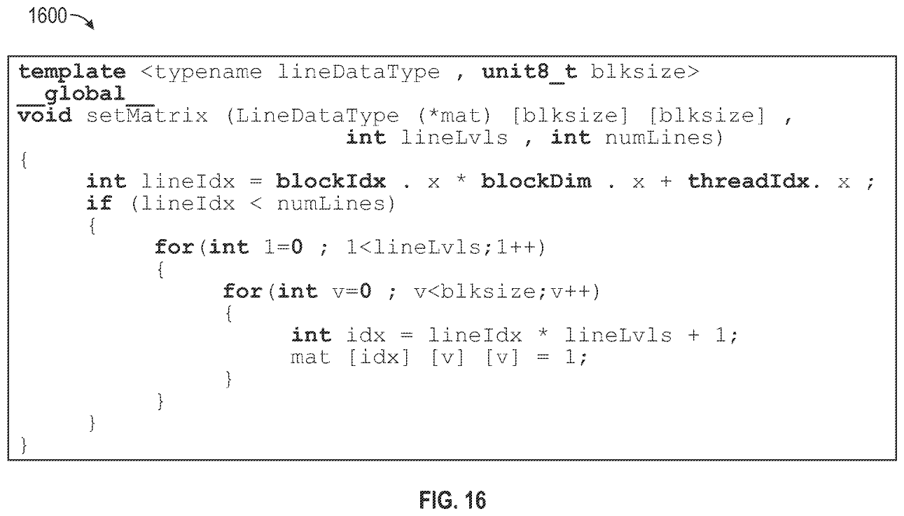

FIG. 16. shows a simple memory bound GPU kernel code (1600) that does a forward pass over the levels of lines for one tridiagonal system array using a conventional memory layout typical of most CPU implementations. The example is directly applicable to the way the Thomas algorithm loads data to perform on each level during its forward and backward passes. While the example does not perform much “work” on the loaded/stored data it demonstrates the traversal over the levels of the lines similar to an implementation of the Thomas algorithm.

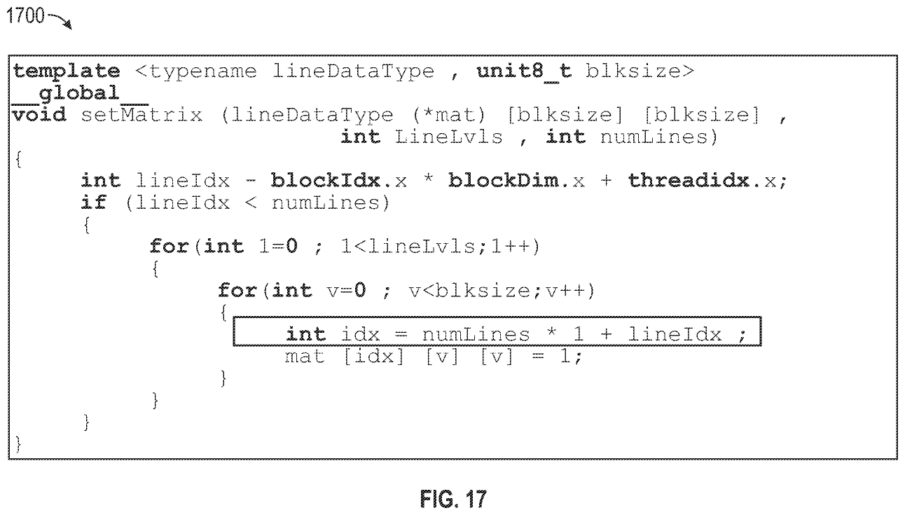

FIG. 17 shows a modified version (1700) of FIG. 16 in which the “int idx” of the kernel code is updated with the assumption that the tridiagonal system data is arranged in a level-based data layout or arrangement.

Table I shows a test of the two kernels; namely, the conventional line-based (as shown in FIG. 16) and level-based (as shown in FIG. 17) were run and reported by the Nvidia profiler. In this simple example the level-based implementation is approximately 4 time faster than the conventional approach.

TABLE I
Comparison of run-time results between the line-based and level-
based implementations.
Comparison of Kernels

| | Time | |
|---|---|---|
| | (ms) | Setup Parameters |
| Conventional | 17.203 | Void setMatrix < double, unsigned char = |
| Line-Based | | 3 > (double[unsigned char = 3][unsigned |
| | | char = 3]*, int, int) |
| New Invention | 4.461 | Void setMatrix < double, unsigned char = |
| Level-Based | | 3 > (double[unsigned char = 3][unsigned |
| | | char = 3]*, int, int) |

FIG. 18 depicts a block diagram of the computer system (1802) used to provide computational functionalities associated with described algorithms, methods, functions, processes, flows, and procedures as described in this disclosure, according to one or more embodiments. The illustrated computer (1802) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1802) may include a computer that includes an input device, such as a keypad, keyboard, touch screen, or other device that can accept user information, and an output device that conveys information associated with the operation of the computer (1802), including digital data, visual, or audio information (or a combination of information), or a Graphical User Interface (GUI).

The computer (1802) can serve in a role as a client, network component, a server, a database or other persistency, or any other component (or a combination of roles) of a computer system for performing the subject matter described in the instant disclosure. The illustrated computer (1802) is communicably coupled with a network (1830). In some implementations, one or more components of the computer (1802) may be configured to operate within environments, including cloud-computing-based, local, global, or other environment (or a combination of environments).

At a high level, the computer (1802) is an electronic computing device operable to receive, transmit, process, store, or manage data and information associated with the described subject matter. According to some implementations, the computer (1802) may also include or be communicably coupled with an application server, e-mail server, web server, caching server, streaming data server, business intelligence (BI) server, or other server (or a combination of servers).

The computer (1802) can receive requests over network (1830) from a client application (for example, executing on another computer (1802)) and responding to the received requests by processing the requests in an appropriate software application. In addition, requests may also be sent to the computer (1802) from internal users (for example, from a command console or by other appropriate access method), external or third-parties, other automated applications, as well as any other appropriate entities, individuals, systems, or computers.

Each of the components of the computer (1802) can communicate using a system bus (1803). In some implementations, any or all of the components of the computer (1802), both hardware or software (or a combination of hardware and software), may interface with each other or the interface (1804) (or a combination of both) over the system bus (1803) using an application programming interface (API) (1812) or a service layer (1813) (or a combination of the API (1812) and service layer (1813). The API (1812) may include specifications for routines, data structures, and object classes. The API (1812) may be either computer-language independent or dependent and refer to a complete interface, a single function, or even a set of APIs. The service layer (1813) provides software services to the computer (1802) or other components (whether or not illustrated) that are communicably coupled to the computer (1802). The functionality of the computer (1802) may be accessible for all service consumers using this service layer. Software services, such as those provided by the service layer (1813), provide reusable, defined business functionalities through a defined interface. For example, the interface may be software written in JAVA, C++, or other suitable language providing data in extensible markup language (XML) format or another suitable format. While illustrated as an integrated component of the computer (1802), alternative implementations may illustrate the API (1812) or the service layer (1813) as stand-alone components in relation to other components of the computer (1802) or other components (whether or not illustrated) that are communicably coupled to the computer (1802). Moreover, any or all parts of the API (1812) or the service layer (1813) may be implemented as child or sub-modules of another software module, enterprise application, or hardware module without departing from the scope of this disclosure.

The computer (1802) includes an interface (1804). Although illustrated as a single interface (1804) in FIG. 18, two or more interfaces (1804) may be used according to particular needs, desires, or particular implementations of the computer (1802). The interface (1804) is used by the computer (1802) for communicating with other systems in a distributed environment that are connected to the network (1830). Generally, the interface (1804 includes logic encoded in software or hardware (or a combination of software and hardware) and operable to communicate with the network (1830). More specifically, the interface (1804) may include software supporting one or more communication protocols associated with communications such that the network (1830) or interface's hardware is operable to communicate physical signals within and outside of the illustrated computer (1802).

The computer (1802) includes at least one computer processor (1805). Although illustrated as a single computer processor (1805) in FIG. 18, two or more processors may be used according to particular needs, desires, or particular implementations of the computer (1802). Generally, the computer processor (1805) executes instructions and manipulates data to perform the operations of the computer (1802) and any algorithms, methods, functions, processes, flows, and procedures as described in the instant disclosure.

The computer (1802) also includes a memory (1806) that holds data for the computer (1802) or other components (or a combination of both) that can be connected to the network (1830). For example, memory (1806) can be a database storing data consistent with this disclosure. Although illustrated as a single memory (1806) in FIG. 18, two or more memories may be used according to particular needs, desires, or particular implementations of the computer (1802) and the described functionality. While memory (1806) is illustrated as an integral component of the computer (1802), in alternative implementations, memory (1806) can be external to the computer (1802).

The application (1807) is an algorithmic software engine providing functionality according to particular needs, desires, or particular implementations of the computer (1802), particularly with respect to functionality described in this disclosure. For example, application (1807) can serve as one or more components, modules, applications, etc. Further, although illustrated as a single application (1807), the application (1807) may be implemented as multiple applications (1807) on the computer (1802). In addition, although illustrated as integral to the computer (1802), in alternative implementations, the application (1807) can be external to the computer (1802).

There may be any number of computers (1802) associated with, or external to, a computer system containing computer (1802), wherein each computer (1802) communicates over network (1830). Further, the term “client,” “user,” and other appropriate terminology may be used interchangeably as appropriate without departing from the scope of this disclosure. Moreover, this disclosure contemplates that many users may use one computer (1802), or that one user may use multiple computers (1802).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
receiving a tridiagonal matrix system for each of M strongly connected lines in a hydrocarbon reservoir, wherein M is an integer greater than or equal to 1, and wherein each tridiagonal matrix system comprises:
an unknown potential array containing a number of levels;
storing, according to a level-based data layout, the M tridiagonal matrix systems in a memory of a graphical processing unit (GPU);
determining, using the GPU, the unknown potential array for each of the tridiagonal matrix systems simultaneously by using a Thomas method configured to operate with the level-based data layout.

2. The method of claim 1, further comprising:
determining, using a computer processor, a computational reservoir model, wherein the reservoir model comprises formation data for each of a plurality of reservoir cells and fluid pressure data for each of the plurality of reservoir cells;
forming, using the computer processor, the M tridiagonal matrix systems based, at least in part, on the computational reservoir model; and
determining the flow profile and production rate of each of one or more wells that traverse the hydrocarbon reservoir based on the determined potential arrays of each of the tridiagonal matrix systems.

3. The method of claim 2 further comprising:
simulating a wellbore based on the computational reservoir model; and
planning the simulated wellbore to penetrate the hydrocarbon reservoir, wherein the planned wellbore comprises a planned wellbore path.

4. The method of claim 3, further comprising drilling the planned wellbore guided by the planned wellbore path.

5. The method of claim 1, wherein the unknown potential array represents a fluid potential field.

6. The method of claim 1, wherein each of the tridiagonal matrix systems further comprise:
a lower diagonal array,
a central diagonal array,
an upper diagonal array, and
a right-hand side array,
wherein the arrays of each of the tridiagonal systems each have N elements where N is equal to the number of levels.

7. The method of claim 6, wherein the level-based data layout is a 2D array comprising a first row, a second row, a third row, and a fourth row,
wherein the first row consists of the first element of the lower diagonal array for each of the M tridiagonal matrix systems followed by the second element of the lower diagonal array of each of the M tridiagonal matrix systems and so on until the Nth element of the lower diagonal array for each of the M tridiagonal matrix systems;
wherein the second row consists of the first element of the central diagonal array for each of the M tridiagonal matrix systems followed by the second element of the central diagonal array of each of the M tridiagonal matrix systems and so on until the Nth element of the central diagonal array for each of the M tridiagonal matrix systems;
wherein the third row consists of the first element of the upper diagonal array for each of the M tridiagonal matrix systems followed by the second element of the upper diagonal array of each of the M tridiagonal matrix systems and so on until the Nth element of the upper diagonal array for each of the M tridiagonal matrix systems; and
wherein the fourth row consists of the first element of the right-hand side array for each of the M tridiagonal matrix systems followed by the second element of the right-hand side array of each of the M tridiagonal matrix systems and so on until the Nth element of the right-hand side array for each of the M tridiagonal matrix systems.

8. A system, comprising:
a computational reservoir simulator configured to simulate a hydrocarbon reservoir; and
a computer processor configured to:
receive a tridiagonal matrix system for each of M strongly connected lines in the hydrocarbon reservoir, wherein M is an integer greater than or equal to 1, and wherein each tridiagonal matrix system comprises:
an unknown potential array containing a number of levels,
store, according to a level-based data layout, the M tridiagonal matrix systems in a memory of a graphical processing unit (GPU), determine, using the GPU, the unknown potential array for each of the tridiagonal matrix systems simultaneously by using a Thomas method configured to operate with the level-based data layout, and
determine the flow profile and production rate of each of one or more wells that traverse the hydrocarbon reservoir with a reservoir simulation based on the
determined potential arrays of each of the tridiagonal matrix systems using the computational reservoir simulator.

9. The system of claim 8, wherein the computer processor is further configured to:
simulate a proposed wellbore with the computational reservoir simulator.

10. The system of claim 9, further comprising a wellbore planning system configured to plan a wellbore to penetrate the hydrocarbon reservoir based on the proposed wellbore, wherein the planned wellbore comprises a planned wellbore path.

11. The system of claim 10, further comprising a wellbore drilling system configured to drill a wellbore guided by the planned wellbore path.

12. The system of claim 8, wherein the reservoir simulation comprises formation data for each of a plurality of reservoir cells and fluid pressure data for each of the plurality of reservoir cells.

13. The system of claim 8, wherein the computer processor is further configured to:
form the M tridiagonal matrix systems based, at least in part, on the computational reservoir simulator.

14. The system of claim 8, wherein the unknown potential array represents a fluid potential field.

15. The system of claim 8, wherein each of the tridiagonal matrix systems further comprise:
a lower diagonal array,
a central diagonal array,
an upper diagonal array, and
a right-hand side array,
wherein the arrays of each of the tridiagonal systems each have N elements where N is equal to the number of levels.

16. The system of claim 15, wherein the level-based data layout is a 2D array comprising a first row, a second row, a third row, and a fourth row,
wherein the first row consists of the first element of the lower diagonal array for each of the M tridiagonal matrix systems followed by the second element of the lower diagonal array of each of the M tridiagonal matrix systems and so on until the Nth element of the lower diagonal array for each of the M tridiagonal matrix systems;
wherein the second row consists of the first element of the central diagonal array for each of the M tridiagonal matrix systems followed by the second element of the central diagonal array of each of the M tridiagonal matrix systems and so on until the Nth element of the central diagonal array for each of the M tridiagonal matrix systems;
wherein the third row consists of the first element of the upper diagonal array for each of the M tridiagonal matrix systems followed by the second element of the upper diagonal array of each of the M tridiagonal matrix systems and so on until the Nth element of the upper diagonal array for each of the M tridiagonal matrix systems; and
wherein the fourth row consists of the first element of the right-hand side array for each of the M tridiagonal matrix systems followed by the second element of the right-hand side array of each of the M tridiagonal matrix systems and so on until the Nth element of the right-hand side array for each of the M tridiagonal matrix systems.

17. A non-transitory computer readable medium storing instructions executable by a computer processor, the instructions comprising functionality for:
receiving a tridiagonal matrix system for each of M strongly connected lines in a hydrocarbon reservoir, wherein M is an integer greater than or equal to 1, and wherein each tridiagonal matrix system comprises:
an unknown potential array containing a number of levels;
storing, according to a level-based data layout, the M tridiagonal matrix systems in a memory of a graphical processing unit (GPU);
determining, using the GPU, the unknown potential array for each of the tridiagonal matrix systems simultaneously by using a Thomas method configured to operate with the level-based data layout.

18. The non-transitory computer readable medium of claim 17, further comprising functionality for:
determining a computational reservoir model, wherein the reservoir model comprises formation data for each of a plurality of reservoir cells and fluid pressure data for each of the plurality of reservoir cells;
forming, using the computer processor, the M tridiagonal matrix systems based, at least in part, on the computational reservoir model; and
determining the flow profile and production rate of each of one or more wells that traverse the hydrocarbon reservoir based on the determined potential arrays of each of the tridiagonal matrix systems.

19. The non-transitory computer readable medium of claim 17, wherein each of the tridiagonal matrix systems further comprise:
a lower diagonal array,
a central diagonal array,
an upper diagonal array, and
a right-hand side array,
wherein the arrays of each of the tridiagonal systems each have N elements where N is equal to the number of levels.

20. The non-transitory computer readable medium of claim 19, wherein the level-based data layout is a 2D array comprising a first row, a second row, a third row, and a fourth row,
wherein the first row consists of the first element of the lower diagonal array for each of the M tridiagonal matrix systems followed by the second element of the lower diagonal array of each of the M tridiagonal matrix systems and so on until the Nth element of the lower diagonal array for each of the M tridiagonal matrix systems;
wherein the second row consists of the first element of the central diagonal array for each of the M tridiagonal matrix systems followed by the second element of the central diagonal array of each of the M tridiagonal matrix systems and so on until the Nth element of the central diagonal array for each of the M tridiagonal matrix systems;
wherein the third row consists of the first element of the upper diagonal array for each of the M tridiagonal matrix systems followed by the second element of the upper diagonal array of each of the M tridiagonal matrix systems and so on until the Nth element of the upper diagonal array for each of the M tridiagonal matrix systems; and
wherein the fourth row consists of the first element of the right-hand side array for each of the M tridiagonal matrix systems followed by the second element of the right-hand side array of each of the M tridiagonal matrix systems and so on until the Nth element of the right-hand side array for each of the M tridiagonal matrix systems.
